(19) United States
(12) Patent Application Publication
(10) Pub. No.: US 2026/0088611 A1
(43) Pub. Date: Mar. 26, 2026

(54) ELECTROSTATIC DISCHARGE (ESD) PROTECTION CIRCUITRY

(71) Applicant: Intel Corporation, Santa Clara, CA (US)

(72) Inventors: Harry Muljono, San Ramon, CA (US); Raj Dua, Newark, CA (US); Horaira Abu, Fremont, CA (US); Changhong Lin, Cupertino, CA (US)

(21) Appl. No.: 18/890,927

(22) Filed: Sep. 20, 2024

(51) Int. Cl. H02H 9/04

(52) U.S. Cl. CPC H02H 9/046

(57) ABSTRACT

Some embodiments include apparatuses and methods of using the apparatuses. One of the apparatuses includes a conductive pad and an electrostatic discharge (ESD) protection circuitry coupled to the conductive pad. The ESD protection circuitry includes a first diode including a first node coupled to a first supply node, and a first additional node coupled to the conductive pad; a second diode including a second node coupled to the conductive pad, and a second additional node coupled to a second supply node; a resistor including a first resistor node coupled to the conductive pad, and a second resistor node; and a switch circuit including a first node coupled to the first resistor node, and a second node coupled to the second resistor node.

### BACKGROUND

Semiconductor devices or systems often have circuitry formed in or on a semiconductor die. The die usually has an ESD protection circuit that can operate to protect other circuitry of the die from a relatively high voltage generated by an ESD event. Such an ESD event may occur at a conductive connection (e.g., an external pin or conductive contact) on a circuit path of the die. Many conventional ESD solutions are available for designing ESD protection circuits. However, such conventional ESD circuits have remained mainly unchanged over time due in part to requirements associated with ESD protection to meet specific industry specifications. Such conventional ESD protection circuits can limit signaling associated with signal communication between semiconductor devices.

### BRIEF DESCRIPTION OF THE DRAWINGS

FIG. 1 shows an apparatus including ESD protection circuitry, according to some embodiments described herein.

FIG. 2 shows an apparatus including another ESD protection circuitry, according to some embodiments described herein.

FIG. 3 is a flow diagram of an example method of manufacturing an electrostatic discharge (ESD) protection circuitry, according to some embodiments described herein.

FIG. 4 shows a block diagram of an example machine, according to some embodiments described herein.

### DETAILED DESCRIPTION

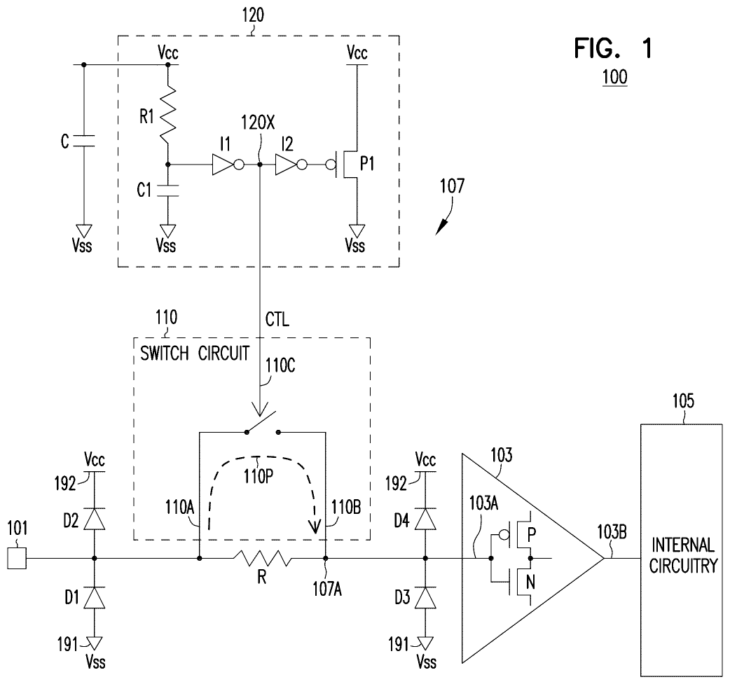

The techniques described herein involve an ESD protection circuitry. The ESD protection circuitry includes a resistor (e.g., ballast resistor) and diodes coupled to a conductive pad to provide ESD protection to internal circuits (e.g., receiver circuits) of a device or system. The ESD protection circuitry includes a switch circuit that can be selectively turned on or turned off by the ESD protection circuitry to reduce RC bandwidth degradation due in part to the presence of the resistor. The ESD protection circuitry can improve bandwidth and signal margin on a signal path coupled to the conductive pad. Other improvements and benefits of the described techniques are discussed below with reference to FIG. 1 through FIG. 4.

FIG. 1 shows an apparatus 100 including ESD protection circuitry 107, according to some embodiments described herein. Apparatus 100 can also include a conductive pad 101, a receiver circuit 103, and an internal circuitry 105. Apparatus 100 can include or be included (e.g., can be a part of) in a system (e.g., electronic system). Such a system can include or be included in a semiconductor chip (e.g., an integrated circuit (IC) chip), cellphone, a tablet, a computer, a system-on-chip (SoC), system-in-package (SiP), system-on-package (SoP), or other types of electronic systems. For simplicity and to help focus on the techniques described herein, other circuitries of apparatus 100 (e.g., an IC chip, SoC, SiP, or SoP) are omitted from FIG. 1.

In FIG. 1, conductive pad 101 can be formed from a conductive material (e.g., metal) or a combination of conductive materials. Conductive pad 101 can include a conductive pin, conductive ball, or other forms of conductive terminals of an IC chip, SoC, SiP, or SoP included in apparatus 100. An example of conductive pad 101 can include an input/output (I/O) conductive pad (e.g., I/O signal pad). In an example, conductive pad 101 can operate to receive a signal (e.g., data signal) sent to apparatus 100 from an external device (not shown).

Receiver circuit 103 can include an input node 103A coupled to a node 107A of ESD protection circuitry 107, and an output node 103B coupled to internal circuitry 105. Receiver circuit 103 can include a transistor P and a transistor N. The gates of respective transistors P and N can be coupled to input node 103A of receiver circuit 103. Transistors P and N can include complementary metal-oxide semiconductor (CMOS) transistor. For example, transistor P can include a p-type transistor (e.g., a p-channel metal-oxide semiconductor (PMOS) transistor). Transistor N can include an n-type transistor (e.g., an n-channel metal-oxide semiconductor (NMOS) transistor).

Receiver circuit 103 can operate to receive a signal (e.g., data signal) from conductive pad 101 through node 107A and pass the signal to output node 103B and then to internal circuitry 105. Internal circuitry 105 can include or can be part of processing circuitry of a central processing unit (CPU), a graphics processing unit (GPU), a combination of a CPU and a GPU, or other types of circuitries of apparatus 100. Internal circuitry 105 can receive the signal from node 103B of receiver circuit 103 for further processing.

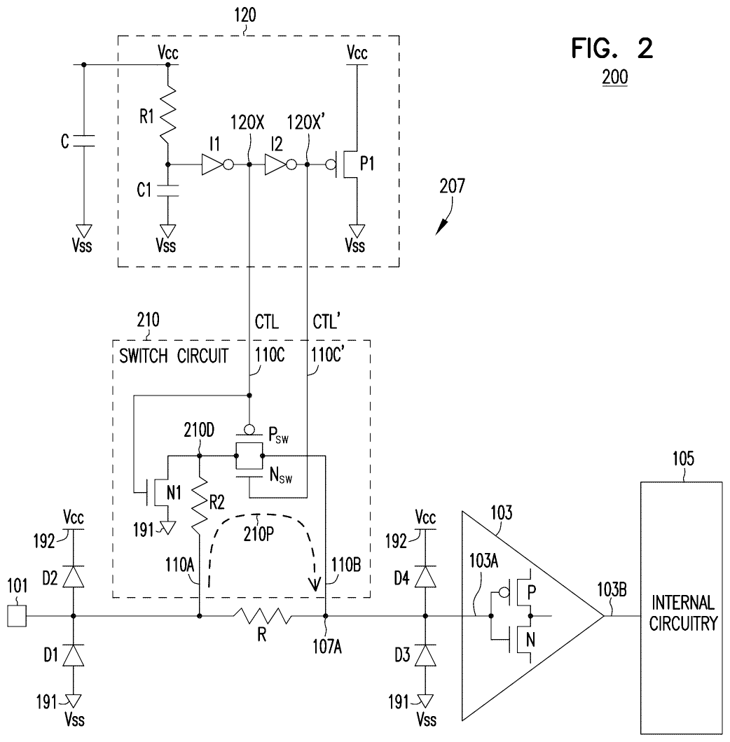

As shown in FIG. 1, apparatus 100 can include supply nodes 191 and 192 to receive voltages (e.g., supply voltages) Vcc and Vss. Supply nodes 191 and 192 can be part supply rails of apparatus 100. Supply voltages Vcc and Vss can be a positive supply voltage and ground potential, respective, of apparatus 100. For simplicity, some of supply nodes 191 and 192 (associated with voltages Vcc and Vss) are not labeled in FIG. 1 (and in FIG. 2).

As shown in FIG. 1, ESD protection circuitry 107 can include diodes D1, D2, D3, and D4 (D1 through D4), a resistor (e.g., a ballast resistor) R, a switch circuit 110, a circuit 120, and a capacitor C. Capacitor C can have a metal-insulator-metal (MIM) structure coupled between nodes 191 and 192. As shown in FIG. 1, resistor R can include nodes (resistor nodes) coupled to conductive pad 101 and node 107A, respectively. Switch circuit 110 can include a node 110A coupled to a node (resistor node) of resistor R, and a node 110B coupled to another node (resistor node) of resistor R. Switch circuit 110 can also include a node (e.g., a control node) 110C coupled to circuit 120 to receive a signal (e.g., switch control signal) CTL. Switch circuit 110 can be controlled (e.g., turn on or turn off) by circuit 120 based on the value (e.g., voltage level) of signal CTL.

Diodes D1, D2, D3, and D4 can include respective nodes (e.g., anodes and cathodes) coupled to conductive pad 101, resistor R, node 107A, and supply nodes 191 and 192 in ways shown in FIG. 1. As shown in FIG. 1, diode D1 can include a node (e.g., an anode) coupled to supply node 191, and a node (e.g., a cathode) coupled to conductive pad 101 and node? 107A (which is coupled to one of the nodes of resistor R). Diode D2 can include a node (e.g., an anode) coupled to conductive pad 101, and a node (e.g., a cathode) coupled to supply node 192. Diode D3 can include a node (e.g., an anode) coupled to supply node 191, and a node (e.g., a cathode) coupled to node 107A (which is coupled to one of the nodes of resistor R). Diode D4 can include a node (e.g., an anode) coupled to node 107A, and a node (e.g., a cathode) coupled to supply node 192.

Apparatus 100 can include (e.g., can operate in) a normal operating mode and an ESD event mode. Apparatus 100 can operate to receive a signal (e.g., data signal) at conductive pad 101 in a normal operating mode. Apparatus 100 can change (e.g., automatically change) to an ESD mode in response to an ESD event (e.g., an ESD event involving conductive pad 101). Switch circuit 110 can be turned on (e.g., enabled) during a normal operating mode and turned off (e.g., disabled) during an ESD event mode.

As shown in FIG. 1, switch circuit 110 can include a circuit path 110P coupled in parallel with resistor R between conductive pad 101 and node 107A. During a normal operating mode of apparatus 100, switch circuit 110 can be turned on to enable (e.g., activate) circuit path 110P and form (create) a conduction path (e.g., a current path) between conductive pad 101 and node 107A through circuit path 110P. This conduction path (by way of circuit path 110P) can reduce the resistance between conductive pad 101 and node 107A (which is coupled to input node 103A of receiver circuit 103) in comparison with the resistance between conductive pad 101 and node 107A without switch circuit 110. The reduced resistance can improve signal bandwidth of a signal path between conductive pad 101 and receiver circuit 103, as further described below. During an ESD event mode of apparatus 100, switch circuit 110 can be turned off to disable (e.g., deactivate) circuit path 110P and not to form a conduction path (e.g., break a conduction path formed by circuit path 110P) between conductive pad 101 and node 107A.

Circuit 120 can operate to detect the presence or absence of an ESD event (e.g., an ESD event involving conductive pad 101) to control (e.g., turn on or turn off) switch circuit 110. For example, circuit 120 can turn on switch circuit 110 when an ESD event is not detected (e.g., when an ESD event does not occur at conductive pad 101). Thus, in this example, in the absence of an ESD event involving conductive pad 101, circuit 120 can operate to form (to enable) a conduction path (e.g., current path) in circuit path 110P, which is coupled between the node of resistor R coupled to node 110A and the node of resistor R coupled to node 110B. In another example, circuit 120 can turn off switch circuit 110 when an ESD event is detected (e.g., when an ESD occurs at conductive pad 101). Thus, in this example, during an occurrence of an ESD event involving conductive pad 101, circuit 120 can operate to disable (e.g., to break) a conduction path (e.g., current path) in circuit path 110P in which the conduction path was formed (in the absence of an ESD event) between the node of resistor R coupled to node 110A and the node of resistor R coupled to node 110B. During an ESD event, resistor R can operate to provide sufficient voltage drop (IR drop) to prevent the voltage on node 107A from causing damage to receiver circuit 103 during an ESD event. In an example, resistor R can have a resistance value of 50 Ohms. However, resistor R can have other resistance values.

Circuit 120 can also be part of a power clamp circuit of ESD protection circuitry 107 in which the power clamp circuit can operate to prevent a voltage in ESD protection circuitry 107 (e.g., the voltage at supply node 191 or 192) from exceeding a voltage that may damage ESD protection circuitry 107 during an ESD event. As shown in FIG. 1, circuit 120 can include a resistor R1, a capacitor C1, inverters I1 and I2, and a transistor P1 coupled to each other and to supply nodes 191 and 192 as shown in FIG. 1. Transistor P1 can include a PMOS transistor. Resistor R1 and capacitor C1 can create an RC (resistor-capacitor) network to form an RC timer (timer logic circuit) to control ESD clamp function of circuit 120 (during an ESD event) and control (e.g., selectively turn on or turn off) switch circuit 110.

As shown in FIG. 1, circuit 120 can include a node 120X between inverters I1 and I2. Inverter I1 includes an input node coupled to a node between resistor R1 and capacitor C1, and an output node coupled to node 120X. Inverter I2 includes an input node coupled to node 120X, and an output node coupled to the gate of transistor P1. Node 120X can be coupled to node (e.g., control node) 110C of switch circuit 110. The level of signal (e.g., switch control signal) CTL at node 110C can based on the voltage value at node 120X.

Switch circuit 110 can be controlled (e.g., turned on or turned off) based on the level of signal CTL. For example, during a normal operating mode of apparatus 100, the voltage at node 120X can have a voltage value corresponding to a logic 0 (e.g., CTL=logic 0 or binary 0). Switch circuit 110 can be structured (e.g., can include at least one transistor) such that it can be turned on in response to the voltage at node 120X having a voltage value corresponding to a logic 0 (e.g., during a normal operating mode). Circuit path 110P can be enabled when switch circuit 110 is turned on. The enabled circuit path 110P can allow a signal (e.g., data signal) to go from conductive pad 101 to node 107A mainly through circuit path 111P (e.g., bypassing or significantly bypassing resistor R).

Switch circuit 110 can be such that it can be turned off (e.g., automatically turned off) in response to the voltage at node 120X having a voltage value corresponding to a logic 1 (e.g., during an ESD event). During an ESD event (e.g., an ESD event occurring at conductive pad 101), ESD protection circuitry 107 (including diode D1-D4 and circuit 120) can operate to diverge ESD current (e.g., current from conductive pad 101) to limit the voltage build up at node 107A, thereby protecting receiver circuit 103. For example, during an ESD event, supply node 192 can be quickly charged by ESD current. This causes the voltage at node 120X of circuit 120 to change from a voltage level corresponding logic 0 (e.g., CTL=logic 0 or binary 0) to a voltage level corresponding logic 1 (e.g., CTL=logic 1 or binary 1). This in turn causes switch circuit 110 to turn off, thereby disabling circuit path 110P between conductive pad 101 and node 101A.

Including switch circuit 110 in ESD protection circuitry 107 and controlling switch circuit 110 as described herein can provide improvements and benefits to apparatus 100 in comparison to some conventional ESD circuits. For example, ESD protection circuitry 107 may still operate to provide ESD protection (e.g., to protect receiver circuit 103) in the absence of switch circuit 110 (in which switch circuit 110 is not included in ESD protection circuitry 107). However, parasitic capacitance on node 107A and the resistance of resistor R become an intrinsic RC stage that degrades bandwidth. This degradation may be exacerbated in some situations (e.g., in situations involving a relatively high-speed I/O signal path associated with conductive pad 101). Some conventional techniques to improve bandwidth extension include the use of inductor coil to reduce the parasitic capacitance. However, the intrinsic RC bandwidth degradation still exists because resistor R remains in the ESD protection circuitry. Further, the use of inductor coil increases the cost of area and circuit complexity.

In apparatus 100, including switch circuit 110 in ESD protection circuitry 107 and controlling switch circuit 110 as described herein can reduce (e.g., minimize) the impact of RC bandwidth degradation associated with resistor R. For example, switch circuit 110 can be implemented with (e.g., can include) at least one pass gate transistor (e.g., at least one CMOS transistor as shown in FIG. 2) coupled in parallel with resistor R between conductive pad 101 and node 107A. Such a pass gate transistor may add negligible parasitic capacitance on node 107A. Thus, the RC bandwidth (with the inclusion of switch circuit 110 of FIG. 1) can be improved by a factor based on the on-resistance of circuit path 107P. The on-resistance of circuit path 107P is the resistance of circuit path 107P while switch circuit 110 is turned on (while circuit path 107P is enabled). As an example, if the on-resistance of circuit path 107P is similar to (e.g., is equal to) the resistance of resistor R, then the RC bandwidth will be increased by two times relative to the RC bandwidth in the absence of switch circuit 110. A greater bandwidth extension (e.g., an RC bandwidth greater than two times the RC bandwidth in the absence of switch circuit 110) can be achieved by selecting (e.g., optimizing) the on-resistance of circuit path 110P. Thus, although resistor R still exists in ESD protection circuitry as part of ESD protection function, switch circuit 110 can improve bandwidth and signal margin on a signal path in apparatus 100 (e.g., signal path from conductive pad 101 to receiver 103). The techniques described herein may have insignificant impact to power consumption of apparatus 100 due to the static nature of the switch circuit (e.g., switch circuit 110 or 210 in FIG. 2) described herein. The technique described herein can be useful for bandwidth extension for relatively high-speed interfaces.

FIG. 2 shows an apparatus 200 including ESD protection circuitry 207, according to some embodiments described herein. Apparatus 200 can substitute for apparatus 100 in devices and systems such as IC chip, SoC, SiP, SoP, and other devices and systems. Apparatus 200 includes structures (circuit elements) and operations similar to that of apparatus 100. For example, apparatus 200 can include conductive pad 101, receiver circuit 103, and ESD protection circuitry 207. For simplicity, similar or the same elements between apparatuses 100 and 200 are given the same labels and their descriptions and operations are not repeated.

Differences in apparatuses 100 and 200 include details of ESD protection circuitry 207 of apparatus 200. As shown in FIG. 2, ESD protection circuitry 207 can include a switch circuit 210 coupled to conductive pad 101 and node 107A. Switch circuit 210 can include a transistor P_{SW}, a transistor N_{SW}, a resistor R2, and a transistor N1. Transistor P_{SW} includes a gate coupled to node 110′C, and terminals (e.g., source and drain) coupled to respective nodes of resistor R. As shown in FIG. 2, one of the terminals (e.g., source or drain) of transistor P_{SW} can be coupled to resistor R through resistor R2. Transistor N_{SW} includes a gate coupled to a node (e.g., a control node) 110C′ of switch circuit 210, and terminals (e.g., source and drain) coupled to respective nodes of resistor R. As shown in FIG. 2, one of the terminals (e.g., source or drain) of transistor N_{SW} can be coupled to resistor R through resistor R2.

As shown in FIG. 2, node 110C′ can be coupled to node 120X′ of circuit 120. Node 110X′ can provide a signal (e.g., switch control signal) CTL′. The level of signal CTL′ can based on the voltage value at node 120X′. The levels of signals CTL and CTL′ can be complementary to each other.

As shown in FIG. 2, switch circuit 210 can include a circuit path 210P coupled in parallel with resistor R between conductive pad 101 and node 107A. Transistor P_{SW}, transistor N_{SW}, and resistor R2 can be part of circuit path 210P. Transistor N_{SW} can include an NMOS transistor. Transistor P_{SW} can include a PMOS transistor. Transistor N1 can include an NMOS transistor. Resistor R2 can have a resistance value less than the resistance value of resistor R. For example, resistor R2 can have a resistance value of less than 50 Ohms.

In an alternative structure of apparatus 200 either transistor P_{SW} or N_{SW} can be omitted from ESD protection circuitry 207. For example, transistor P_{SW} can be omitted from ESD protection circuitry 207, such that circuit path 210P includes (e.g., include only) transistor N_{SW} and resistor R. In another example, transistor N_{SW} can be omitted from ESD protection circuitry 207, such that circuit path 210P includes (e.g., include only) transistor P_{SW} and resistor R.

Switch circuit 210 can operate in ways similar to that of switch circuit 110 of FIG. 1. For example, during a normal operating mode of apparatus 200, switch circuit 210 can be turned on to enable (e.g., activate) circuit path 210P and form (create) a conduction path (e.g., a current path) between conductive pad 101 and node 107A through the activated circuit path 210P. During a normal operating mode, transistors P_{SW} and N_{SW} are turned on based on the voltages at node 120X and 120X′, respectively (e.g., CTL=logic 0 and CTL′=logic 1). The turned-on transistors P_{SW} and N_{SW and} resistor R2 are part of the conduction path between conductive pad 101 and node 107A through the activated circuit path 210P.

During an ESD event mode of apparatus 200, switch circuit 210 can be turned off to disable (e.g., deactivate) circuit path 210P and not to form a conduction path (e.g., break a conduction path formed by circuit path 210P) between conductive pad 101 and node 107A. During an ESD event, transistors P_{SW} and N_{SW} are turned off based on the voltages at node 120X and 120X′, respectively (e.g., CTL=logic 1 and CTL′=logic 0). The turned-off transistors P_{SW} and N_{SW disable} conduction path between conductive pad 101 and node 107A.

Transistor N1 can operate as a current sink to prevent damage to switch circuit 210 in an ESD event. For example, without transistor N1, the voltage at node 210D during an ESD event (e.g., an ESD event at conductive pad 101) can damage transistor P_{SW}, transistor N_{SW}, or both. However, such a damage can be prevented with the inclusion of transistor N1. For example, during an ESD event, the voltage at node 110C (e.g., CTL=logic 1) can cause transistor N1 to turn on. The turned-on transistor N1 forms a conduction path between node 210D and a supply node (e.g., ground node 191). This conduction path allows current to go to supply node 191 through the turned-on transistor N1 and protect transistor P_{SW} and transistor N_{SW} from damage.

Resistor R2 can operate to provide a voltage difference between conductive pad 101 and node 210D. The voltage difference allows proper operation (allow transistor to turn on) during an ESD event. Resistor R2 can also operate to reduce the voltage at node 210D to prevent damage (e.g., physical damage) to transistor P_{SW}, transistor N_{SW}, or both, during an ESD event.

ESD protection circuitry 207 can provide improvements and benefits similar to that of ESD protection circuitry 107 of FIG. 1.

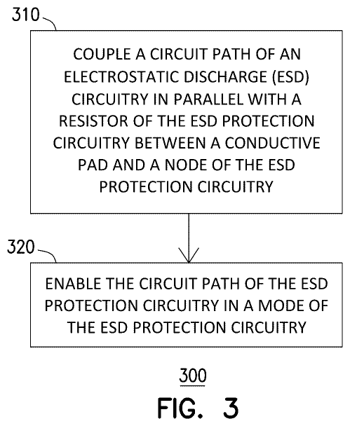

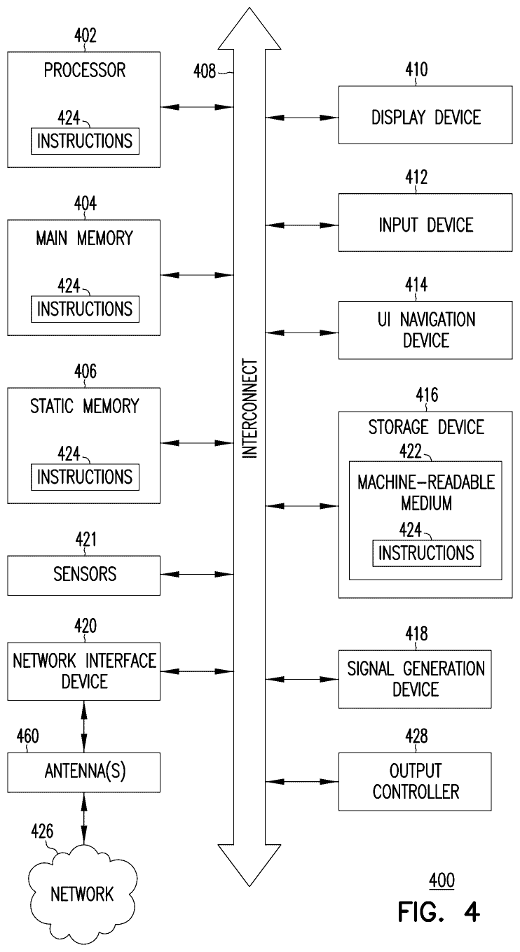

FIG. 3 is a flow diagram of an example method 300 of manufacturing an electrostatic discharge (ESD) protection circuitry, according to some embodiments described herein. As shown in FIG. 3, method 300 can include operations 310 and 320, which may be executed by an embedded controller or another processor of a computing device (e.g., hardware processor 402 of machine 400 illustrated in FIG. 4, which can include one or more of the circuits discussed in connection with FIG. 1 and FIG. 2). In some embodiments, one or more of the circuits discussed in connection with FIG. 1 and FIG. 2 can perform the functionalities (e.g., operations) shown in FIG. 3 and in the examples listed below.

Operation 310 can include coupling a circuit path of an ESD protection circuitry in parallel with a resistor of the ESD protection circuitry between a conductive pad and a node of the ESD protection circuitry. The ESD protection circuitry of method 300 can include ESD protection circuitry 107 or 207. The circuit path of method 300 can include circuit path 110P or 210P.

Operation 320 can include enabling the circuit path of the ESD protection circuitry in a mode of the ESD protection circuitry. The mode can include a normal operating mode (which is different from an ESD event mode).

Method 300 can include fewer or more operations than the operations shown in FIG. 3. For example, method 300 can include operations of apparatus 100 or apparatus 200 described above. Method 300 can also include operations described in the examples (e.g., examples 1-42) listed below.

FIG. 4 shows a block diagram of an apparatus in the form of an example machine (e.g., an electronic system) 400 upon which any one or more of the techniques (e.g., methodologies) discussed herein may perform. In alternative embodiments, the machine 400 may operate as a standalone device or may be connected (e.g., networked) to other machines. In a networked deployment, machine 400 may operate in the capacity of a server machine, a client machine, or both in server-client network environments. In an example, machine 400 may function as a peer machine in a peer-to-peer (P2P) (or other distributed) network environment. The machine 400 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is shown, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

The apparatus including machine 400 may be configured to perform one or more of the methods and/or operations disclosed herein. The apparatus may be intended as a component of machine 400 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

Machine (e.g., computer system) 400 may include a hardware processor 402 (e.g., a central processing unit (CPU), a graphics processing unit (GPU), a hardware processor core, or any combination thereof), a main memory 404, and a static memory 406, some or all of which may communicate with each other via an interconnect (e.g., bus) 408. In some aspects, main memory 404, static memory 406, or any other type of memory (including cache memory) used by machine 400 can be configured based on the disclosed techniques or can implement the disclosed memory devices.

Specific examples of main memory 404 include Random Access Memory (RAM) and semiconductor memory devices, which may include, in some embodiments, storage locations in semiconductors such as registers. Specific examples of static memory 406 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 400 may further include a display device 410, an input device 412 (e.g., a keyboard), and a user interface (UI) navigation device 414 (e.g., a mouse). In an example, display device 410, input device 412, and UI navigation device 414 may be a touchscreen display. The machine 400 may additionally include a storage device (e.g., drive unit or another mass storage device) 416, a signal generation device 418 (e.g., a speaker), a network interface device 420, and one or more sensors 421, such as a global positioning system (GPS) sensor, compass, accelerometer, or other sensors. Machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, hardware processor 402 and/or instructions 424 may comprise processing circuitry and/or transceiver circuitry.

Storage device 416 may include a machine-readable medium 422 on which one or more sets of data structures or instructions 424 (e.g., software) embodying or utilized by any one or more of the techniques or functions described herein can be stored. Instructions 424 may also reside, completely or at least partially, within the main memory 404, within static memory 406, or hardware processor 402 during execution thereof by machine 400. In an example, one or any combination of hardware processor 402, main memory 404, static memory 406, or storage device 416 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

FIG. 4 shows the machine-readable medium 422 as a single medium as an example. However, the term “machine-readable medium” may include a single medium or multiple media (e.g., a centralized or distributed database and/or associated caches and servers) configured to store instructions 424.

The term “machine-readable medium” may include any medium that is capable of storing, encoding, or carrying instructions for execution by machine 400 and that causes machine 400 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

Instructions 424 may further be transmitted or received over a communications network 426 using a transmission medium via network interface device 420 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 302.11 family of standards known as Wi-Fi®, IEEE 302.16 family of standards known as WiMax®), IEEE 302.8.4 family of standards, a Long Term Evolution (LTE) family of standards, a Universal Mobile Telecommunications System (UMTS) family of standards, peer-to-peer (P2P) networks, among others.

In an example, network interface device 420 may include one or more physical jacks (e.g., Ethernet, coaxial, or phone jacks) or one or more antennas to connect to communications network 426. In an example, network interface device 420 may include a connector, in which the connector conforms with at least one of Universal Serial Bus (USB), High-Definition Multimedia Interface (HDMI), Thunderbolt, Peripheral Component Interconnect Express (PCIe), and Ethernet specifications. In an example, network interface device 420 may include one or more antennas 460 to wirelessly communicate using at least one single-input multiple-output (SIMO), multiple-input multiple-output (MIMO), or multiple-input single-output (MISO) techniques. In some examples, network interface device 420 may wirelessly communicate using multiple-user MIMO techniques. The term “transmission medium” shall be taken to include any intangible medium that can store, encode, or carry instructions for execution by machine 400 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of an IC chip, a system (e.g., a system in the form of machine 400, a system on chip, a system-in-package, a system-on-package, or a combination of these systems), a set of intercommunicating functional blocks, or similar, although the scope of the disclosure is not limited in this respect.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, the term “adjacent” generally refers to a position of a thing being next to (e.g., either immediately next to or close to with one or more things between them) or adjoining another thing (e.g., abutting it or contacting it (e.g., directly coupled to) it).

In the detailed description and the claims, the terms “first”, “second”, and “third,” etc. are used merely as labels, and are not intended to impose numerical requirements on their objects.

In the detailed description and the claims, a list of items joined by the term “at least one of” can mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A can include a single element or multiple elements. Item B can include a single element or multiple elements. Item C can include a single element or multiple elements.

In the detailed description and the claims, a list of items joined by the term “one of” can mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A can include a single element or multiple elements. Item B can include a single element or multiple elements. Item C can include a single element or multiple elements.

Described implementations of the subject matter can include one or more features, alone or in combination as illustrated below by way of examples.

Example 1 is an electronic apparatus comprising a conductive pad, and an electrostatic discharge (ESD) protection circuitry coupled to the conductive pad, the ESD protection circuitry including a first diode including a first node coupled to a first supply node, and a first additional node coupled to the conductive pad, a second diode including a second node coupled to the conductive pad, and a second additional node coupled to a second supply node, a resistor including a first resistor node coupled to the conductive pad, and a second resistor node, and a switch circuit including a first node coupled to the first resistor node, and a second node coupled to the second resistor node.

In Example 2, the subject matter of Example 1 includes subject matter wherein the ESD protection circuitry includes a third diode including a third node coupled to the first supply node, and a third additional node coupled to the second resistor node, and a fourth diode including a fourth node coupled to the second resistor node, and a fourth additional node coupled to the second supply node.

In Example 3, the subject matter of any of Examples 1-2 includes subject matter wherein the switch circuit includes a transistor, the transistor including a gate coupled to a control node of the switch circuit, a first terminal coupled to the first resistor node, and a second terminal coupled to the second resistor node.

In Example 4, the subject matter of Example 3 includes subject matter wherein the switch circuit includes an additional transistor, the additional transistor including an additional gate coupled to an additional control node of the switch circuit, a first additional terminal coupled to the first terminal of the transistor, and a second additional terminal coupled to the second terminal of the transistor.

In Example 5, the subject matter of any of Examples 1-4 includes subject matter wherein the ESD protection circuitry includes a resistor-capacitor (RC) network, and an inverter coupled to the RC network, the inverter including an output node coupled to a control node of the switch circuit.

In Example 6, the subject matter of Example 3 includes subject matter wherein the ESD protection circuitry includes an additional transistor including an additional gate, a first additional terminal coupled to the first terminal of the switch circuit, and a second additional terminal coupled to the first supply node.

In Example 7, the subject matter of any of Examples 1-6 includes a receiver circuit, the receiver circuit including an input node coupled to the second resistor node.

In Example 8, the subject matter of any of Examples 1-7 includes subject matter wherein the apparatus comprises a system, the system comprising an integrated circuit (IC), the IC comprising the conductive pad and the ESD protection circuitry.

In Example 9, the subject matter any of Examples 1-8 includes subject matter wherein the system further comprises at least one connector, and wherein the at least one connector conforms with at least one of Universal Serial Bus (USB), High-Definition Multimedia Interface (HDMI), Thunderbolt, Peripheral Component Interconnect Express (PCIe), and Ethernet specifications.

In Example 10, the subject matter of any of Examples 1-2 includes a transistor, the transistor including a gate coupled to the second resistor node.

In Example 11, the subject matter of Example 10 includes an additional transistor, the addition transistor including an additional gate coupled to the second resistor node.

In Example 12, the subject matter of any of Examples 1-11 includes subject matter wherein the ESD protection circuitry includes a circuit to turn off the switch in response to an ESD involving the conductive pad.

In Example 13, the subject matter of any of Examples 1-11 includes subject matter wherein the ESD protection circuitry includes a circuit to turn on the switch in an absence of an ESD involving the conductive pad.

In Example 14, the subject matter of Example 3 includes subject matter wherein the transistor includes a p-type transistor.

In Example 15, the subject matter of Example 3 includes subject matter wherein the transistor includes an n-type transistor.

Example 16 is an electronic apparatus comprising a conductive pad, and an electrostatic discharge (ESD) protection circuitry coupled to the conductive pad, the ESD protection circuitry including a first diode including a first anode coupled to a first supply node, and a first cathode coupled to the conductive pad, a second diode including a second anode coupled to the conductive pad, and a second cathode coupled to a second supply node, a resistor including a first resistor node coupled to the conductive pad, and a second resistor node, a third diode including a third anode coupled to the first supply node, and a third cathode coupled to the second resistor node, a fourth diode including a fourth anode coupled to the second resistor node, and a fourth cathode coupled to the second supply node, and a circuit path coupled in parallel with the resistor between the first resistor node and the second resistor node.

In Example 17, the subject matter of Example 16 includes subject matter wherein the circuit path includes a transistor, the transistor including a gate, a first terminal coupled to the first resistor node, and a second terminal coupled to the second resistor node.

In Example 18, the subject matter of Example 17 includes subject matter wherein the transistor is a first transistor, and the circuit path includes a second transistor, the second transistor including an additional gate, a first additional terminal coupled to the first resistor node, and a second additional terminal coupled to the second resistor node.

In Example 19, the subject matter of Example 18 includes subject matter wherein the ESD protection circuitry includes a circuit, the circuit including an additional resistor and a capacitor coupled between the first supply and the second supply node, a first inverter coupled between the gate of the first transistor and a node between the additional resistor and the capacitor, and a second inverter coupled between the gate of the first transistor and the additional gate of the second transistor.

In Example 20, the subject matter of Example 18 includes subject matter wherein the ESD protection circuitry includes a third transistor, the third transistor including a gate coupled to the gate of the first transistor, a first terminal coupled to the first terminal of the first transistor, and a second terminal coupled to the first supply node.

In Example 21, the subject matter of Example 18 includes subject matter wherein the ESD protection circuitry includes an additional resistor including a first node to the first resistor node, and a second node coupled to the first terminal of the first transistor, and an additional transistor including a gate coupled to the gate of the first transistor, a first terminal coupled to the first terminal of the first transistor, and a second terminal coupled to the first supply node.

In Example 22, the subject matter of any of Examples 16-21 includes a receiver circuit, the receiver circuit including an input node coupled to the second resistor node.

In Example 23, the subject matter of any of Examples 16-22 includes subject matter wherein the apparatus comprises a system, the system comprising an integrated circuit (IC), the IC comprising the conductive pad and the ESD protection circuitry.

In Example 24, the subject matter of any of Examples 16-23 includes subject matter wherein the system further comprises at least one connector, and wherein the at least one connector conforms with at least one of Universal Serial Bus (USB), High-Definition Multimedia Interface (HDMI), Thunderbolt, Peripheral Component Interconnect Express (PCIe), and Ethernet specifications.

In Example 25, the subject matter of any of Examples 16-24 includes a transistor, the transistor including a gate coupled to the second resistor node.

In Example 26, the subject matter of Example 25 includes an additional transistor, the addition transistor including an additional gate coupled to the second resistor node.

In Example 27, the subject matter of any of Examples 16-26 includes subject matter wherein ESD protection circuitry includes an inverter coupled between the gate of the first transistor and the additional gate of the second transistor.

In Example 28, the subject matter of Example 21 includes subject matter wherein the resistor has a first resistance value, and the additional resistor has a second resistance value less than the first resistance value.

In Example 29, the subject matter of any of Examples 16-28 includes subject matter wherein the ESD protection circuitry includes a circuit to form a conduction path in the circuit path between the first resistor node and the second resistor through the conduction path in an absence of an ESD event involving the conductive pad.

In Example 30, the subject matter of any of Examples 16-28 includes subject matter wherein the ESD protection circuitry includes a circuit to disable the conduction path during an occurrence of an ESD event involving the conductive pad.

Example 31 is a method of manufacturing an electrostatic discharge (ESD) protection circuitry, comprising: coupling a circuit path of the ESD protection circuitry in parallel with a resistor of the ESD protection circuitry between a conductive pad and a node of the ESD protection circuitry, and enabling the circuit path of the ESD protection circuitry in a mode of the ESD protection circuitry.

In Example 32, the subject matter of Example 31 includes subject matter wherein enabling the circuit path includes turning on a switch circuit on the circuit path.

In Example 33, the subject matter of Example 32 further includes disabling the circuit path in an ESD mode of the ESD protection circuitry.

In Example 34, the subject matter of any of Examples 32-33 includes subject matter wherein enabling the circuit path includes turning on a transistor of the circuit path, the transistor including a first terminal coupled to a first node of the resistor, and a second terminal coupled to a second node of the resistor.

In Example 35, the subject matter of any of Examples 32-33 includes subject matter wherein disabling the circuit path includes turning off a transistor of the circuit path, the transistor including a first terminal coupled to a first node of the resistor, and a second terminal coupled to a second node of the resistor.

In Example 36, the subject matter of any of Examples 34-35 includes subject matter wherein enabling the circuit path includes turning on an additional transistor of the circuit path, the transistor including a first additional terminal coupled to the first terminal of the transistor, and a second additional terminal coupled to the second terminal of the transistor.

In Example 37, the subject matter of any of Examples 34-35 includes subject matter wherein disabling the circuit path includes turning off an additional transistor of the circuit path, the additional transistor including a first additional terminal coupled to the first terminal of the transistor, and a second additional terminal coupled to the second terminal of the transistor.

In Example 38, the subject matter of any of Examples 34-37 includes forming a conduction path between the first terminal of the transistor and a supply node.

Example 39 is at least one machine-readable medium including instructions that, when executed by processing circuitry, cause the processing circuitry to perform operations to implement any of Examples 1-38.

Example 40 is an apparatus comprising means to implement any of Examples 1-38.

Example 41 is a system to implement any of Examples 1-38.

Example 42 is a method to implement any of Examples 1-38.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above detailed description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the detailed description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a conductive pad; and
an electrostatic discharge (ESD) protection circuitry coupled to the conductive pad, the ESD protection circuitry including:
a first diode including a first node coupled to a first supply node, and a first additional node coupled to the conductive pad;
a second diode including a second node coupled to the conductive pad, and a second additional node coupled to a second supply node;
a resistor including a first resistor node coupled to the conductive pad, and a second resistor node; and
a switch circuit including a first node coupled to the first resistor node, and a second node coupled to the second resistor node.

2. The apparatus of claim 1, wherein the ESD protection circuitry includes:
a third diode including a third node coupled to the first supply node, and a third additional node coupled to the second resistor node; and
a fourth diode including a fourth node coupled to the second resistor node, and a fourth additional node coupled to the second supply node.

3. The apparatus of claim 1, wherein the switch circuit includes a transistor, the transistor including a gate coupled to a control node of the switch circuit, a first terminal coupled to the first resistor node, and a second terminal coupled to the second resistor node.

4. The apparatus of claim 3, wherein the switch circuit includes an additional transistor, the additional transistor including an additional gate coupled to an additional control node of the switch circuit, a first additional terminal coupled to the first terminal of the transistor, and a second additional terminal coupled to the second terminal of the transistor.

5. The apparatus of claim 1, wherein the ESD protection circuitry includes a resistor-capacitor (RC) network, and an inverter coupled to the RC network, the inverter including an output node coupled to a control node of the switch circuit.

6. The apparatus of claim 3, wherein the ESD protection circuitry includes an additional transistor including an additional gate, a first additional terminal coupled to the first terminal of the switch circuit, and a second additional terminal coupled to the first supply node.

7. The apparatus of claim 1, further comprising a receiver circuit, the receiver circuit including an input node coupled to the second resistor node.

8. The apparatus of claim 1, wherein the apparatus comprises a system, the system comprising an integrated circuit (IC), the IC comprising the conductive pad and the ESD protection circuitry.

9. The apparatus of claim 8, wherein the system further comprises at least one connector, and wherein the at least one connector conforms with at least one of Universal Serial Bus (USB), High-Definition Multimedia Interface (HDMI), Thunderbolt, Peripheral Component Interconnect Express (PCIe), and Ethernet specifications.

10. An apparatus comprising:
a conductive pad; and
an electrostatic discharge (ESD) protection circuitry coupled to the conductive pad, the ESD protection circuitry including:
a first diode including a first anode coupled to a first supply node, and a first cathode coupled to the conductive pad;
a second diode including a second anode coupled to the conductive pad, and a second cathode coupled to a second supply node;
a resistor including a first resistor node coupled to the conductive pad, and a second resistor node;
a third diode including a third anode coupled to the first supply node, and a third cathode coupled to the second resistor node;
a fourth diode including a fourth anode coupled to the second resistor node, and a fourth cathode coupled to the second supply node; and
a circuit path coupled in parallel with the resistor between the first resistor node and the second resistor node.

11. The apparatus of claim 10, wherein the circuit path includes a transistor, the transistor including a gate, a first terminal coupled to the first resistor node, and a second terminal coupled to the second resistor node.

12. The apparatus of claim 11, wherein the transistor is a first transistor, and the circuit path includes a second transistor, the second transistor including an additional gate, a first additional terminal coupled to the first resistor node, and a second additional terminal coupled to the second resistor node.

13. The apparatus of claim 12, wherein the ESD protection circuitry includes a circuit, the circuit including:
an additional resistor and a capacitor coupled between the first supply and the second supply node;
a first inverter coupled between the gate of the first transistor and a node between the additional resistor and the capacitor; and
a second inverter coupled between the gate of the first transistor and the additional gate of the second transistor.

14. The apparatus of claim 12, wherein the ESD protection circuitry includes a third transistor, the third transistor including a gate coupled to the gate of the first transistor, a first terminal coupled to the first terminal of the first transistor, and a second terminal coupled to the first supply node.

15. The apparatus of claim 12, wherein the ESD protection circuitry includes:
an additional resistor including a first node to the first resistor node, and a second node coupled to the first terminal of the first transistor; and
an additional transistor including a gate coupled to the gate of the first transistor, a first terminal coupled to the first terminal of the first transistor, and a second terminal coupled to the first supply node.

16. The apparatus of claim 10, further comprising a receiver circuit, the receiver circuit including an input node coupled to the second resistor node.

17. The apparatus of claim 10, wherein the apparatus comprises a system, the system comprising an integrated circuit (IC), the IC comprising the conductive pad and the ESD protection circuitry.

18. The apparatus of claim 10, wherein the system further comprises at least one connector, and wherein the at least one connector conforms with at least one of Universal Serial Bus (USB), High-Definition Multimedia Interface (HDMI), Thunderbolt, Peripheral Component Interconnect Express (PCIe), and Ethernet specifications.

19. A method of manufacturing an electrostatic discharge (ESD) protection circuitry, comprising:
coupling a circuit path of the ESD protection circuitry in parallel with a resistor of the ESD protection circuitry between a conductive pad and a node of the ESD protection circuitry; and
enabling the circuit path of the ESD protection circuitry in a mode of the ESD protection circuitry.

20. The method of claim 19, wherein enabling the circuit path includes turning on a switch circuit on the circuit path.
